(19) United States
(12) Patent Application Publication
(10) Pub. No.: US 2007/0053944 A1
(43) Pub. Date: Mar. 8, 2007

(54) Concentrated suspensions

(75) Inventor: Ronald Vermeer, Leverkusen (DE)

Correspondence Address: BAYER CROPSCIENCE LP;Patent Department, 100 BAYER ROAD, PITTSBURGH, PA, 15205-9741, US

(73) Assignee: BAYER CROPSCIENCE AKTIENGESELLSCHAFT, Monheim (DE)

(21) Appl. No.: 10/572,719

(22) PCT Filed: Sep. 10, 2004
(86) PCT No.: PCT/EP04/10114

§ 371 Date: Mar. 21, 2006

(30) Foreign Application Priority Data
Sep. 23, 2003 (DE) 103 43 872.6

(51) Int. Cl. A01N 25/00

(52) U.S. Cl. 424/405

(57) ABSTRACT

Novel suspension concentrates comprising a) at least one active compound, solid at room temperature, from the group of the azoles and/or the strobilurins, b) at least one penetration enhancer from the group of the alkanolethoxylates, c) at least one dispersant from the group of the polymers of methyl 2-methyl-2-propenoate and α-(2-methyl-1-oxo-2-propenyl)-ω-methoxypoly(oxy-1,2-ethanediyl), the tristyrylphenolethoxylates and/or the propylene oxide/ethylene oxide block copolymers having molecular weights between 8000 and 10 000, d) water and also e) additives, if appropriate, a process for preparing the novel suspension concentrates and their use for applying the active compounds comprised therein to plants and/or their habitat.

The invention relates to suspension concentrates agrochemically active compounds, to a process for preparing these formulations and to their use for applying the active compounds comprised therein.

Numerous suspension concentrates of agrochemically active compounds are already known. Thus, suspension concentrates of tebuconazole which, in addition to this fungicidally active compound and customary additives, also comprise alkali metal sulfosuccinates as formulation auxiliaries, have already been described (cf. EP-A 0 897 665). The biological activity of the ready-to-use sprays prepared from these suspension concentrates is good. However, they have the disadvantage that their activity is weaker than that of sprays obtainable by diluting corresponding emulsion concentrates with water.

This invention now provides novel suspension concentrates comprising
a) at least one active compound, solid at room temperature, from the group of the azoles and/or the strobilurins,
b) at least one penetration enhancer from the group of the alkanolethoxylates,
c) at least one dispersant from the group
   of the polymers of methyl 2-methyl-2-propenoate and α-(2-methyl-1-oxo-2-propenyl)-ω-methoxypoly(oxy-1,2-ethanediyl),
   the tristyrylphenolethoxylates and/or
   the propylene oxide/ethylene oxide block copolymers having molecular weights between 8000 and 10 000,
d) water and also
e) additives, if appropriate.

Furthermore, it has been found that the suspension concentrates according to the invention can be prepared in an advantageous manner by
initially mixing penetration enhancers from the group (b), dispersants from the group (c) and also water and, if appropriate, additives from the group (e),
then adding at least one active compound from the group (a), comminuting the resulting suspension by grinding, and
then adding water and, if appropriate, further additives.

Finally, it has been found that the suspension concentrates according to the invention are highly suitable for applying the agrochemically active compounds comprised therein to plants.

It has to be considered extremely surprising that the sprays preparable by diluting the suspension concentrates according to the invention with water show, in the treatment of plants, a considerably better biological activity than sprays obtainable from the corresponding customary suspension concentrates. In particular, it is unexpected that the biological activity of the sprays obtained by diluting suspension concentrates according to the invention with water come close to the activity of sprays obtainable from the corresponding emulsion concentrates.

The suspension concentrates according to the invention have a number of advantages. Thus, they can be prepared without any problems. Furthermore, it is advantageous that, on storage of the suspension concentrates according to the invention, there is neither unwanted crystal growth nor agglomeration of the particles comprised therein. Likewise, no interfering side effects are observed on dilution of the suspension concentrates according to the invention with water. Finally, the formulations according to the invention enhance the biological activity of the active components comprised therein so that, compared to customary suspension preparations, either a higher activity is achieved or less active compound is required.

The suspension concentrates according to the invention comprise one or more solid active compounds from the group of the azoles and/or the strobilurins.

In this context, the following fungicidally active compounds may be mentioned as examples of azoles:

a) triazoles:
azaconazole, bitertanol, bromuconazole, cyproconazole, diclobutrazole, difenoconazole, diniconazole, epoxiconazole, etaconazole, fenbuconazole, fluquinconazole, flusilazole, flutriafol, hexaconazole, imibenconazole, ipconazole, metconazole, myclobutanil, paclebutrazol, penconazole, propiconazole, prothioconazole, simeconazole, tebuconazole, tetraconazole, triadimefon, triadimenol, triticonazole; and

b) imidazoles:
imazalil, oxpoconazole fumarate, peforazoate, prochloraz, triflumizole.

Preference is given to:
tebuconazole, prothioconazole, triadimefon, triadimenol, bitertanol, diclobutrazole, propiconazole, difenoconazole, cyproconazole, flutriafol, hexaconazole, myclobutanil, penconazole, etaconazole, bromuconazole, epoxiconazole, fenbuconazole, tetraconazole, diniconazole, triticonazole, flusilazole, prochloraz, metconazole, ipconazole and fluquinconazole.

The following fungicidally active compounds may be mentioned as examples of strobilurins which may be present in the suspension concentrates according to the invention:
azoxystrobin, dimoxystrobin, famoxadone, fenamidone, fluoxastrobin, kresoxim-methyl, metaminostrobin, picoxystrobin, pyraclostrobin and trifloxystrobin.

Preference is given to:
trifloxystrobin, fluoxastrobin, kresoxim-methyl, azoxystrobin, picoxystrobin, pyraclostrobin and metominostrobin.

The suspension concentrates according to the invention comprise one or more penetration enhancers from the group of the alkanolethoxylates. Here, preference is given to alkanolethoxylates of the formula
CH₃—(CH₂)ₘ—O [symbol] CH₂—CH₂—O [symbol] ₙH (I)
in which
m represents numbers from 9 to 17 and
n represents numbers from 8 to 16.

Particular preference is given to compounds of the formula (I) in which
m represents numbers from 9 to 13 and
n represents numbers from 8 to 12.

Alkanolethoxylate of the formula (I), in which
m represents 11 and
n represents 10
   may be mentioned by way of example.

This is the substance which, inter alia, is commercially available under the name Genapol C 100® (from Clariant).

The formulae above provide a general definition of the alkanolethoxylates. These substances are generally mixtures of compounds of the stated type having different chain lengths. Accordingly, for the indices, average values are calculated which may not be integers.

The alkanolethoxylates of the formula (I) are known or can be prepared by known methods (cf. WO 98-35 553, WO 00-35 278 and EP-A 0 681 865).

The suspension concentrates according to the invention preferably comprise a mixture of two different dispersants from the group of the compounds mentioned under (c). Preferred are the substances mentioned below.

Polymer of methyl 2-methyl-2-propenoate and α-(2-methyl-1-oxo-2-propenyl)-ω-methoxy-poly(oxy-1,2-ethanediyl) having the Cas No. 111 740-364 which is commercially available under the name Atlox 4913® (from Uniqema).

Furthermore, tristyrylphenolethoxylates having an average of 29 to 60, preferably 50 to 60, oxyethylene units. Moreover sulfated or phosphated tristyrylphenolethoxylates having an average of 29 to 60, preferably 50 to 60, oxyethylene units, and also salts of these substances. Specific mention may be made of the commercial products known under the names Soprophor FLK (from Rhodia), Soprophor TS 54 (from Rhodia) and Soprophor TS 60 (from Rhodia).

Moreover propylene oxide/ethylene oxide block copolymers having molecular weights between 8000 and 10 000 and an ethylene oxide proportion of between 40 and 60% by weight, where the products commercially available under the names Pluronic PE 10 100 (from BASF), Pluronic PE 10 500 (from BASF) and Pluronic F 68 (from BASF) may be mentioned by way of example.

Particular preference is given to suspension concentrates according to the invention comprising the following combinations of dispersants:
Atlox 4913 and Soprophor TS 60,
Atlox 4913 and Pluronic PE 10 500 or
Pluronic PE 10 500 and Soprophor FLK.

Suitable additives which may be comprised in the suspension concentrates according to the invention are antifoams, antifreeze agents, preservatives, antioxidants, colorants, vegetable oils, thickeners and inert fillers.

Suitable defoaners include all substances which can normally be used for this purpose in agrochemical compositions. Preference is given to silicone oils and magnesium stearate.

Suitable preservatives include all substances which can normally be used for this purpose in agrochemical compositions of this type. Examples that may be mentioned include Preventol® (from Bayer AG) and Proxel® (from Bayer AG).

Suitable antioxidants are all substances which can normally be used for this purpose in agrochemical compositions. Preference is given to butylated hydroxytoluene.

Suitable colorants include all substances which can normally be used for this purpose in agrochemical compositions. Examples that may be mentioned include titanium dioxide, pigment-grade carbon black, zinc oxide and blue pigments and also permanent red FGR.

Suitable inert fillers include all substances which can normally be used for this purpose in agrochemical compositions and which do not act as thickeners. Preference is given to inorganic particles, such as carbonates, silicates and oxides, and also to organic substances, such as urea/formaldehyde condensates. By way of example, kaolin, rutile, silica, finely divided silica, silica gels, and natural and synthetic silicates, and also talc may be mentioned.

Suitable vegetable oils include all oils which can normally be used in agrochemical compositions and which can be obtained from plants. Examples that may be mentioned include sunflower oil, rapeseed oil, olive oil and soybean oil.

Suitable antifreeze agents include all compounds which can normally be used for this purpose in agrochemical compositions. Examples that may be mentioned include urea, glycerol and propylene glycol.

Suitable thickeners include all substances which can normally be used for this purpose in agrochemical compositions. An example which may be mentioned is the xanthan-based product commercially available under the name Kelzane S (from CP Kelco).

Besides, the suspension concentrates according to the invention also comprise water.

The content of the individual components in the suspension concentrates according to the invention can be varied within a relatively wide range. Thus, the concentrations
of active compounds from the group (a) are generally between 10 and 40% by weight, preferably between 20 and 30% by weight,
of penetration enhancers from the group (b) are generally between 5 and 20% by weight, preferably between 10 and 15% by weight,
of dispersants from the group (c) are generally between 3 and 8% by weight, preferably between 3 and 5% by weight, and
of additives from the group (e) are generally between 0 and 15% by weight, preferably between 0 and 13% by weight.

The water content in the suspension concentrates according to the invention can be varied within wide limits. Depending on the other components, it is generally between 40 and 65% by weight.

The formulations according to the invention can also be used as a mixture with other known fungicides, bactericides, acaricides, nematicides or insecticides, for example in order to broaden the activity spectrum or to prevent the development of resistances in this way. Compounds which are suitable as mixing partners are, for example, the following:

Fungicides:

2-Phenylphenol; 8-hydroxyquinoline sulphate; acibenzolar-S-methyl; actinovate; aldimorph; amidoflumet; ampropylfos; ampropylfos-potassium; andoprim; anilazine; benalaxyl; benodanil; benomyl; benthiavalicarb-isopropyl; benzamacril; benzamacril-isobutyl; bilanafos; binapacryl; biphenyl; blasticidin-S; boscalid; bupirimate; buthiobate; butylamine; calcium polysulfide; capsimycin; captafol; captan; carbendazim; carboxin; carpropamid; carvone; chinomethionat; chlobenthiazone; chlorfenazole; chloroneb; chlorothalonil; chlozolinate; cis-1-4-chlorophenyl)-2-(1H-1,2,4-triazol-1-yl)-cycloheptanol; clozylacon; cyazofamid; cyflufenamid; cymoxanil; cyprodinil; cyprofuram; Dagger G; debacarb; dichlofluanid; dichlone; dichlorophen; diclocymet; diclomezine; dicloran; diethofencarb; diflumetorim; dimethirimol; dimethomorph; dinocap; diphenylamine; dipyrithione; ditalimfos; dithianon; dodine; drazoxolon; edifenphos; ethaboxam; ethirimol; etridiazole; fenapanil; fenftiram; fenhexamid; fenitropan; fenoxanil; fenpiclonil; fenpropidin; fenpropimorph; ferbam; fluazinam; flubenzimine; fludioxonil; flumetover; flumorph; fluoromide; flurprimidol; flusulfamide; flutolanil; folpet; fosetyl-Al; fosetyl-sodium; fuberidazole; furalaxyl; furametpyr; furcarbanil; furmecyclox; guazatine; hexachlorobenzene; hymexazol; iminoctadine triacetate; iminoctadine tris(albesilate); iodocarb; iprobenfos; iprodione; iprovalicarb; irumamycin; isoprothiolane; isovaledione; kasugamycin; mancozeb; maneb; meferinizone; mepanipyrim; mepronil; metalaxyl; metalaxyl-M; methasulfocarb; methfuroxam; methyl 1-(2,3-dihydro-2,2-dimethyl-1H-inden-1-yl)-1H-imidazole-5-carboxylate; methyl 2-[[[cyclopropyl[(4-methoxyphenyl)imino]methyl]thio]methyl]-α-(methoxymethylene)benzeneacetate; methyl 2-[2-[3-(4-chlorophenyl)-1-methylallylideneaminooxymethyl]phenyl]-3-methoxyacrylate; metiram; metrafenone; metsulfovax; mildiomycin; monopotassium carbonate; myclozolin; N-(3-ethyl-3,5,5-trimethylcyclohexyl)-3-formylamino-2-hydroxybenzamide; N-(6-methoxy-3-pyridinyl)cyclopropanecarboxamide; N-butyl-8-(1,1-dimethylethyl)-1-oxaspiro[4.5]decan-3-amine; natamycin; nitrothal-isopropyl; noviflumuron; ofurace; orysastrobin; oxadixyl; oxolinic acid; oxycarboxin; oxyfenthiin; pencycuron; penthiopyrad; phosdiphen; phthalide; picobenzamid; piperalin; polyoxins; polyoxorim; procymidone; propamocarb; propanosine-sodium; propineb; proquinazid; pyrazophos; pyrimethanil; pyroquilon; pyroxyfur; pyrrolnitrine; quinconazole; quinoxyfen; quintozene; silthiofam; sodium tetrathiocarbonate; spiroxamine; sulfur; tecloftalam; tecnazene; tetcyclacis; thicyofen; thifluzamide; thiophanate-methyl; thiram; tiadinil; tioxymid; tolclofos-methyl; tolylfluanid; triazbutil; triazoxide; tricyclarnide; tricyclazole; tridemorph; validamycin A; vinclozolin; zineb; ziram; zoxamide; (2S)-N-[2-[4-[[3-(4-chlorophenyl)-2-propynyl]oxy]-3-methoxyphenyl]ethyl]-3-methyl-2-[(methylsulfonyl)amino]butanamide; 1-(1 -naphthalenyl)-1H-pyrrole-2,5-dione; 2,3,5,6-tetrachloro-4-(methylsulfonyl)pyridine; 2,4-dihydro-5-methoxy-2-methyl4-[[[[1-[3-(trifluoromethyl)phenyl]ethylidene]amino]oxy]methyl]phenyl]-3H-1,2,3-triazol-3-one; 2-amino-4-methyl-N-phenyl-5-thiazolecarboxamide; 2-chloro-N-(2,3-dihydro-1,1,3-trimethyl-1H-inden-4-yl)-3-pyridinecarboxamide; 3,4,5-trichloro-2,6-pyridinedicarbonitrile; 3-[(3-bromo-6-fluoro-2-methyl-1H-indol-1-yl)sulfonyl]-N,N-dimethyl-1H-1,2,4-triazole-1-sulfonamide;
and copper salts and preparations, such as Bordeaux mixture; copper hydroxide; copper naphthenate; copper oxychloride; copper sulfate; cufraneb; copper oxide; mancopper; oxine-copper:

Bactericides:
Bronopol, dichlorophen, nitrapyrin, nickel dimethyldithiocarbamate, kasugamycin, octhilinon, furancarboxylic acid, oxytetracyclin, probenazole, streptomycin, tecloftalam, copper sulfate and other copper preparations.

Insecticides/Acaricides/Nematicides:
abamectin, ABG-9008, acephate, acequinocyl, acetamiprid, acetoprole, acrinathrin, AKD-1022, AKD-3059, AKD-3088, alanycarb, aldicarb, aldoxycarb, allethrin, allethrin 1R-isomers, alpha-cypermethrin (alphamethrin), amidoflumet, aminocarb, amitraz, avermectin, AZ-60541, azadirachtin, azamethiphos, azinphos-methyl, azinphos-ethyl, azocyclotin,

Bacillus popilliae, Bacillus sphaericus, Bacillus subtilis, Bacillus thuringiensis, Bacillus thuringiensis strain EG-2348, Bacillus thuringiensis strain GC-91, Bacillus thuringiensis strain NCTC-1 1821, baculoviruses, Beauveria bassiana, Beauveria tenella, bendiocarb, ben-furacarb, bensultap, benzoximate, beta-cyfluthrin, beta-cypermethrin, bifenazate, bifenthrin, binapacryl, bioallethrin, bioallethrin-S-cyclopentyl-isomer, bioethanomethrin, biopermethrin, bioresmethrin, bistrifluron, BPMC, brofenprox, bromophos-ethyl, bromopropylate, bromfenvinfos (-methyl), BTG-504, BTG-505, bufencarb, buprofezin, butathiofos, butocarboxim, butoxycarboxim, butylpyridaben,
cadusafos, camphechlor, carbaryl, carbofuran, carbophenothion, carbosulfan, cartap, CGA-50439, chinomethionat, chlordane, chlordimeform, chloethocarb, chlorethoxyfos, chlorfenapyr, chlorfenvinphos, chlorfluazuron, chlormephos, chlorobenzilate, chloropicrin, chlorproxyfen, chlorpyrifos-methyl, chlorpyrifos (-ethyl), chlovaporthrin, chromafenozide, cis-cypermethrin, cis-resmethrin, cis-permethrin, clocythrin, cloethocarb, clofentezine, clothianidin, clothiazoben, codlemone, coumaphos, cyanofenphos, cyanophos, cycloprene, cycloprothrin, Cydia pomonella, cyfluthrin, cyhalothrin, cyhexatin, cypermethrin, cyphenothrin (1R-trans-isomer), cyromazine,
DDT, deltamethrin, demeton-S-methyl, demeton-S-methylsulfone, diafenthiuron, dialifos, diazinon, dichlofenthion, dichlorvos, dicofol, dicrotophos, dicyclanil, diflubenzuron, di-methoate, dimethylvinphos, dinobuton, dinocap, dinotefuran, diofenolan, disulfoton, docusat-sodium, dofenapyn, DOWCO-439,
eflusilanate, emamectin, emamectin-benzoate, empenthrin (1R-isomer), endosulfan, Entomopthora spp., EPN, esfenvalerate, ethiofencarb, ethiprole, ethion, ethoprophos, etofenprox, etoxazole, etrimfos,

famphur, fenamiphos, fenazaquin, fenbutatin oxide, fenfluthrin, fenitrothion, fenobucarb, fenothiocarb, fenoxacrim, fenoxycarb, fenpropathrin, fenpyrad, fenpyrithrin, fenpyroximate, fensulfothion, fenthion, fentrifanil, fenvalerate, fipronil, flonicamid, fluacrypyrim, fluazuron, flubenzimine, flubrocythrinate, flucycloxuron, flucythrinate, flufenerim, flufenoxuron, flufenprox, flumethrin, flupyrazofos, flutenzin (flufenzine), fluvalinate, fonofos, formetanate, formothion, fosmethilan, fosthiazate, fubfenprox (fluproxyfen), furathiocarb,
gamma-HCH, gossyplure, grandlure, granulosis viruses,
halfenprox, halofenozide, HCH, HCN-801, heptenophos, hexaflumuron, hexythiazox, hydramethylnone, hydroprene,
IKA-2002, imidacloprid, imiprothrin, indoxacarb, iodofenphos, iprobenfos, isazofos, isofenphos, isoprocarb, isoxathion, ivermectin,
japonilure,
kadethrin, nuclear polyhedrosis viruses, kinoprene,
lambda-cyhalothrin, lindane, lufenuron,
malathion, mecarbam, mesulfenfos, metaldehyde, metam-sodium, methacrifos, methamidophos, Metharhizium anisopliae, Metharhizium flavoviride, methidathion, methiocarb, methomyl, methoprene, methoxychlor, methoxyfenozide, metolcarb, metoxadiazone, mevinphos, milbemectin, milbemycin, MKI-245, MON45700, monocrotophos, moxidectin, MTI-800,
naled, NC-104, NC-170, NC-184, NC-194, NC-196, niclosamide, nicotine, nitenpyram, nithiazine, NNI-000 1, NNI-0 101, NNI-0250, NNI-9768, novaluron, noviflumuron,
OK-5101, OK-5201, OK-9601, OK-9602, OK-9701, OK-9802, omethoate, oxamyl, oxydemeton-methyl,
Paecilomyces fumosoroseus, parathion-methyl, parathion (-ethyl), permethrin (cis-, trans-), petroleum, PH-6045, phenothrin (IR-trans isomer), phenthoate, phorate, phosalone, phosmet, phosphamidon, phosphocarb, phoxim, piperonyl butoxide, pirimicarb, pirimiphosmethyl, pirimiphos-ethyl, prallethrin, profenofos, promecarb, propaphos, propargite, propetamphos, propoxur, prothiofos, prothoate, protrifenbute, pymetrozine, pyraclofos, pyresmethrin, pyrethrum, pyridaben, pyridalyl, pyridaphenthion, pyridathion, pyrimidifen, pyriproxyfen,
quinalphos,
resmethrin, RH-5849, ribavirin, RU-12457, RU-15525,
S-421, S-1833, salithion, sebufos, SI-0009, silafluofen, spinosad, spirodiclofen, spiromesifen, sulfluramid, sulfotep, sulprofos, SZI-121,
tau-fluvalinate, tebufenozide, tebufenpyrad, tebupirimfos, teflubenzuron, tefluthrin, temephos, temivinphos, terbam, terbufos, tetrachlorvinphos, tetradifon, tetramethrin, tetramethrin (IR-isomer), tetrasul, theta-cypermethrin, thiacloprid, thiamethoxam, thiapronil, thiatriphos, thiocyclam hydrogenoxalate, thiodicarb, thiofanox, thiometon, thiosultap-sodium, thuringiensin, tolfenpyrad, tralocytbrin, tralomethrin, transfluthrin, triarathene, triazamate, triazophos, triazuron, trichlophenidine, trichlorfon, triflumuron, trimethacarb,
vamidothion, vaniliprole, verbutin, Verticillium lecanii,
WL-108477, WL-40027,
YI-5201, YI-5301, YI-5302,
XMC, xylylcarb,
ZA-3274, zeta-cypermethrin, zolaprofos, ZXI-8901,
the compound 3-methylphenyl propylcarbamate (Tsumacide Z),
the compound 3-(5-chloro-3-pyridinyl)-8-(2,2,2-trifluoroethyl)-8-azabicyclo[3.2.1]octane-3-carbonitrile (CAS-Reg. No. 185982-80-3) and the corresponding 3-endo-isomer (CAS-Reg. No. 185984-60-5) (cf. WO 96/37494, WO 98/25923),
and preparations which comprise insecticidally active plant extracts, nematodes, fungi or viruses.

A mixture with other known active compounds, such as herbicides, or with fertilizers and growth regulators, safeners or semiochemicals is also possible.

The suspension concentrates according to the invention are generally prepared by
mixing in a first step the respective desired amounts of penetration enhancers from the group (b), dispersants from the group (c), about half of the required amount of water and also, if appropriate, additives from the group (e) and stirring the mixture until a homogeneous solution is achieved,
then, in a second step, adding with stirring one or more active compounds from the group (a), comminuting the resulting suspension by grinding to the respective desired particle size, and
finally, in a third step, adding with stirring the remainder of the desired amount of water and also, if appropriate, additives, preferably thickeners.

When carrying out the process according to the invention, the temperatures can be varied within a certain range. In general, the first step of the process is carried out at temperatures between 20° C. and 70° C., preferably between 50° C. and 60° C. The subsequent steps are generally carried out at room temperature. However, it is also possible to work at slightly elevated or reduced temperatures.

Suitable for carrying out the process according to the invention are mixers and mills customarily used for preparing agrochemical formulations.

The suspension concentrates according to the invention are formulations which, even after prolonged storage at elevated temperatures or in the cold, remain stable as no crystal growth is observed. By dilution with water, they can be converted into homogeneous spray liquors. These spray liquors are applied by customary methods, i.e., for example, by spraying, pouring or injecting.

The application rate of the suspension concentrates according to the invention can be varied within a relatively wide range. It depends on the respective agrochemically active compounds and their content in the formulations.

With the aid of the suspension concentrates according to the invention, it is possible to apply agrochemically active compounds in a particularly advantageous manner to plants and/or their habitat. Here, the agrochemically active compounds comprised therein display better biological activity than on application in the form of the corresponding conventional formulations.

The formulations according to the invention have potent microbicidal activity and can be employed for controlling unwanted microorganisms, such as fungi and bacteria, in crop protection and in the protection of materials.

Fungicides can be employed in crop protection for example for controlling Plasmodiophoromycetes, Oomycetes, Chytridiomycetes, Zygomycetes, Ascomycetes, Basidiomycetes and Deuteromycetes.

Bactericides can be employed in crop protection for example for controlling Pseudomonadaceae, Rhizobiaceae, Enterobacteriaceae, Corynebacteriaceae and Streptomycetaceae.

Some pathogens causing fungal and bacterial diseases which come under the generic names listed above may be mentioned as examples, but not by way of limitation:
Xanthomonas species, such as, for example, Xanthomonas campestris pv. oryzae;
Pseudomonas species, such as, for example, Pseudomonas syringae pv. lachrymans;
Erwinia species, such as, for example, Erwinia amylovora;
Pythium species, such as, for example, Pythium ultimum;
Phytophthora species, such as, for example, Phytophthora infestans;
Pseudoperonospora species, such as, for example, Pseudoperonospora humuli or Pseudoperonospora cubensis;
Plasmopara species, such as, for example, Plasmopara viticola;
Bremia species, such as, for example, Bremia lactucae;
Peronospora species, such as, for example, Peronospora pisi or P. brassicae;
Erysiphe species, such as, for example, Erysiphe graminis;
Sphaerotheca species, such as, for example Sphaerotheca fuliginea;
Podosphaera species, such as, for example, Podosphaera leucotricha;
Venturia species, such as, for example, Venturia inaequalis;
Pyrenophora species, such as, for example, Pyrenophora teres or P. graminea (conidia form: Drechslera, syn: Helminthosporium);
Cochliobolus species, such as, for example, Cochliobolus sativus (conidia form: Drechslera, syn: Helminthosporium);
Uromyces species, such as, for example, Uromyces appendiculatus;
Puccinia species, such as, for example, Puccinia recondita;
Sclerotinia species, such as, for example, Sclerotinia sclerotiorum;
Tilletia species, such as, for example, Tilletia caries;
Ustilago species, such as, for example, Ustilago nuda or Ustilago avenae;
Pellicularia species, such as, for example, Pellicularia sasakii;
Pyricularia species, such as, for example, Pyricularia oryzae;
Fusarium species, such as, for example, Fusarium culmorum;
Botrytis species, such as, for example, Botrytis cinerea;
Septoria species, such as, for example, Septoria nodorum;
Leptosphaeria species, such as, for example, Leptosphaeria nodorum;
Cercospora species, such as, for example, Cercospora canescens;
Alternaria species, such as, for example, Alternaria brassicae; and
Pseudocercosporella species, such as, for example, Pseudocercosporella herpotrichoides.

The formulations according to the invention also show a strong invigorating action in plants. Accordingly, they are suitable for mobilizing the internal defenses of the plant against attack by unwanted microorganisms.

In the present case, unwanted microorganisms are to be understood as meaning phytopathogenic fungi and bacteria. The formulations according to the invention can thus be used to protect plants within a certain period of time after treatment against attack by the pathogens mentioned.

The fact that the formulations are well tolerated by plants at the concentrations required for controlling plant diseases permits a treatment of above-ground parts of plants, of propagation stock and seeds, and of the soil.

Here, the active compounds according to the invention can be used with particularly good results for controlling cereal diseases, such as, for example, against Erysiphe species, diseases in viticulture and the cultivation of fruits and vegetables, such as, for example, against Botrytis, Venturia, Sphaerotheca and Podosphaera species.

The formulations according to the invention are also suitable for increasing the yield of crops. In addition, they show reduced toxicity and are well tolerated by plants.

According to the invention, it is possible to treat all plants and parts of plants. Plants are to be understood here as meaning all plants and plant populations, such as desired and undesired wild plants or crop plants (including naturally occuning crop plants). Crop plants can be plants which can be obtained by conventional breeding and optimization methods or by biotechnological and genetic engineering methods or combinations of these methods, including the transgenic plants and including plant cultivars which can or cannot be protected by plant breeders' certificates. Parts of plants are to be understood as meaning all above-ground and below-ground parts and organs of plants, such as shoot, leaf, flower and root, examples which may be mentioned being leaves, needles, stems, trunks, flowers, fruit-bodies, fruits and seeds and also roots, tubers and rhizomes. Parts of plants also include harvested material and vegetative and generative propagation material, for example seedlings, tubers, rhizomes, cuttings and seeds.

The invention is illustrated by the examples below.

### PREPARATION EXAMPLES

### Example 1

To prepare a suspension concentrate,
23 g of Atlox 4913,
8 g of Soprophor TS 60,
150 g of Genapol C 100,
50 g of propylene glycol,
1 g of Preventol D 7,
2 g of Proxel GXL,
1 g of silicone oil and
315 g of water
   are mixed with one another and, at temperatures between 50° C. and 60° C., stirred until a homogeneous solution is achieved. At room temperature, 250 g of tebuconazole are added with stirring to this solution. The resulting homogeneous suspension is subjected initially to coarse grinding and then to fine grinding, giving a suspension in which 90% of the solid particles have a particle size below 5 microns. At room temperature,
2 g of Kelzane S and
198 g of water
   are then added with stirring. This gives a homogeneous suspension concentrate.

### Example 2

To prepare a suspension concentrate
23 g of Atlox 4913,
16 g of Pluronic PE 10 500,
100 g of Genapol C 100,
30 g of propylene glycol,
80 g of sunflower oil,
2 g butylated hydroxytoluene,
1 g of Preventol D 7,
2 g of Proxel GXL,
1 g of silicone oil and
344 g of water
   are mixed with one another and, at temperatures between 50° C. and 60° C., stirred until a homogeneous solution is achieved. At room temperature, 250 g of tebuconazole are added with stirring to this solution. The resulting homogeneous suspension is subjected initially to coarse grinding and then to fme grinding, giving a suspension in which 90% of the solid particles have a particle size below 5 microns. At room temperature,
1 g of Kelzane S and
149 g of water
   are then added with stirring. This gives a homogeneous suspension concentrate.

### Example 3

To prepare a suspension concentrate,
23 g of Atlox 4913,
4 g of Soprophor TS 60,
100 g of Genapol C 100,
50 g of propylene glycol,
1 g of Preventol D 7,
2 g of Proxel GXL,
1 g of silicone oil and
419 g or water
   are mixed with one another and, at temperatures between 50° C. and 60° C., stirred until a homogeneous solution is achieved. At room temperature, 200 g of trifloxystrobin are added with stirring to this solution. The resulting homogeneous suspension is subjected initially to coarse grinding and then to fine grinding, giving a suspension in which 90% of the solid particles have a particle size below 5 microns. At room temperature,
3 g of Kelzane S and
197 g of water
   are then added with stirring. This gives a homogeneous suspension concentrate.

### Example 4

To prepare a suspension concentrate,
40 g of Atlox 4913,
4 g of Soprophor TS 60,
100 g of Genapol C 100,
50 g of glycerol
1 g of Preventol D 7,
2 g of Proxel GXL,
1 g of silicone oil and
446 g of water
   are mixed with one another and, at temperatures between 50° C. and 60° C., stirred until a homogeneous solution is achieved. At room temperature, 100 g of prothioconazole and 100 g of fluoxastrobin are added with stirring to this solution. The resulting homogeneous suspension is subjected initially to coarse grinding and then to fine grinding, giving a suspension in which 90% of the solid particles have a particle size below 5 microns. At room temperature,
2 g of Kelzane S and
148 g of water
   are then added with stirring. This gives a homogeneous suspension concentrate.

### Example 5

To prepare a suspension concentrate,
10 g of Pluronic PE 10 500,
50 g of Soprophor FLK,
100 g of Genapol C 100,
100 g of urea,
1 g of Preventol D 7,
2 g of Proxel GXL,
1 g of silicone oil and
286 g of water
   are mixed with one another and, at temperatures between 50° C. and 60° C., stirred until a homogeneous solution is achieved. At room temperature, 200 g of tebuconazole and 100 g of trifloxystrobin are added with stirring to this solution. The resulting homogeneous suspension is subjected initially to coarse grinding and then to fine grinding, giving a suspension in which 90% of the solid particles have a particle size below 5 microns. At room temperature,
2 g of Kelzane S and
148 g of water
   are then added with stirring. This gives a homogeneous suspension concentrate.

### Use Examples

### Example A

Leptosphaeria nodorum test (winter wheat)/protective

The following ready-to-use sprays are prepared by diluting
a commercially available tebuconazole emulsion concentrate (=formulation I),
suspension concentrate according to example 1 (=formulation II) and
suspension concentrate according to example 2 (=formulation III)
   in each case with the desired amount of water.

Outdoors, winter wheat plants are sprayed at the two-leaf stage with the active compound preparations at an application rate such that the amounts of active compound stated in the table below are applied per hectare. One day after the treatment, the plants are inoculated with a spore suspension of Leptosphaeria nodorum.

Evaluation is carried out after three weeks by determining the infection of the plants and expressing it in percent. 0% means that no infection is observed, and 100% means an infection which corresponds to that of the untreated control.

Formulations, active compound application rates and test results are shown in the table below.

TABLE A
Leptosphaeria nodorum (winter wheat)/protective

| | Tebuconazole | |
|---|---|---|
| | application rate in | Degree of infection |
| Formulation | g/ha | in % |
| — | 0 | 100 |
| (Control) | | |
| Known: | 250 | 3 |
| (I) | 125 | 25 |
| | 62.5 | 35 |
| According to the | 250 | 12 |
| invention: | 125 | 27 |
| (II) | 62.5 | 29 |
| According to the | 250 | 6 |
| invention: | 125 | 28 |
| (III) | 62.5 | 34 |

### Example B

Erysiphe test (winter wheat)/protective

The following ready-to-use sprays are prepared by diluting
a commercially available tebuconazole emulsion concentrate (=formulation I),
suspension concentrate according to example 1 (=formulation II) and
suspension concentrate according to example 2 (=formulation III)
   in each case with the desired amount of water.

Outdoors, winter wheat plants are sprayed at the one-leaf stage with the active compound preparations at an application rate such that the amounts of active compound stated in the table below are applied per hectare. One day after the treatment, the plants are dusted with spores of Erysiphe graminis f. sp. tritici.

Evaluation is carried out after three weeks by determining the infection of the plants and expressing it in percent. 0% means that no infection is observed, and 100% means an infection which corresponds to that of the untreated control.

Formulations, active compound application rates and test results are shown in the table below.

TABLE B
Erysiphe test (winter wheat)/protective

| | Tebuconazole | |
|---|---|---|
| | application rate in | Degree of infection |
| Formulation | g/ha | in % |
| — | 0 | 100 |
| (Control) | | |
| Known: | 250 | 3 |
| (I) | 125 | 6 |
| | 62.5 | 33 |
| According to the | 250 | 9 |
| invention: | 125 | 9 |
| (II) | 62.5 | 18 |
| According to the | 250 | 3 |
| invention: | 125 | 6 |
| (III) | 62.5 | 6 |

1. A suspension concentrate, characterized in that it comprises
a) at least one active compound, solid at room temperature, from the group of the azoles and/or the strobilurins,
b) at least one penetration enhancer from the group of the alkanolethoxylates,
c) at least one dispersant from the group
of the polymers of methyl 2-methyl-2-propenoate and α-(2-methyl-1-oxo-2-propenyl)-ω-methoxypoly(oxy-1,2-ethanediyl),
the tristyrylphenolethoxylates and/or
the propylene oxide/ethylene oxide block copolymers having molecular weights between 8000 and 10 000,
d) water and also
e) additives, if appropriate.

2. The suspension concentrate as claimed in claim 1, characterized in that it comprises, as active compounds of group (a),
a) triazoles:
azaconazole, bitertanol, bromuconazole, cyproconazole, diclobutrazole, difenoconazole, diniconazole, epoxiconazole, etaconazole, fenbuconazole, fluquinconazole, flusilazole, flutriafol, hexaconazole, imibenconazole, ipconazole, metconazole, myclobutanil, paclebutrazol, penconazole, propiconazole, prothioconazole, simeconazole, tebuconazole, tetraconazole, triadimefon, triadimenol, triticonazole; and
b) imidazoles:
imazalil, oxpoconazole fumarate, peforazoate, prochloraz, triflumizole.

3. The suspension concentrate as claimed in claim 1, characterized in that it comprises, as active compound of group (a), azoxystrobin, dimoxystrobin, famoxadone, fenamidone, fluoxastrobin, kresoxim-methyl, metaminostrobin, picoxystrobin, pyraclostrobin and trifloxystrobin.

4. The suspension concentrate as claimed in claim 1, characterized in that it comprises, as active compound of group (a), tebuconazole.

5. The suspension concentrate as claimed in claim 1, characterized in that it comprises, as active compounds of group (a), tebuconazole and trifloxystrobin.

6. The suspension concentrate as claimed in claim 1, characterized in that it comprises, as active compounds of group (a), prothioconazole and fluoxastrobin.

7. The suspension concentrate as claimed in claim 1, characterized in that it comprises, as active compound of group (a), trifloxystrobin.

8. The suspension concentrate as claimed in claim 1, characterized in that it comprises two dispersants from group (c).

9. A process for preparing suspension concentrates as claimed in claim 1, characterized in that
initially penetration enhancers from the group (b), dispersants from the group (c) and also water and, if appropriate, additives from the group (e) are mixed,
at least one active compound from the group (a) is then added, the resulting suspension being conminuted by grinding, and
water and, if appropriate, further additives are then added.

10. The use of suspension concentrates as claimed in claim 1 for applying the agrochemically active compounds comprised therein to plants and/or their habitat.
